(19) United States
(12) Patent Application Publication
(10) Pub. No.: US 2005/0180352 A1
(43) Pub. Date: Aug. 18, 2005

(54) Hub-based communications method and apparatus

(75) Inventors: Robert S. Gerovski, Chicago, IL (US); Matthew Christensen, Winchendon, MA (US); Jonathan Gray, Cary, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Trifus N.A., LLC

(21) Appl. No.: 10/781,392

(22) Filed: Feb. 18, 2004

(51) Int. Cl. H04Q 7/00

(52) U.S. Cl. 370/328

(57) ABSTRACT

A hub operably couples to one or more process management systems and service providers that are each remotely located with respect to the hub. In one embodiment, these elements communicate with one another via the hub through use data translation and manipulation units. The hub can maintain records regarding which data translation and manipulation units are capable of supporting communications with which external services. The hub can also maintain records, in a preferred embodiment, of which external services are authorized to use a given data translation and manipulation unit and/or to otherwise access a given service provider.

### TECHNICAL FIELD

This invention relates generally to hub-based communications.

### BACKGROUND

Communications systems and techniques of various kinds are known in the art. Such approaches typically serve to facilitate the provision of information as between two or more entities. It is known, for example, to facilitate the interaction of a process management system such as a learning management system with a service provider that offers, for example, training course content using a data network such as the Internet. In such a system, the learning management system will often access and/or interact with the course content via an intermediary network entity. This interaction will often include initial process facilitation (such as identification of which course materials should now be provided), provision of the course materials themselves, and provision of any corresponding course metrics (such as identification of those persons who reviewed the course materials, corresponding comprehension scores, and the like) to the learning management system.

Such existing configurations are adequate for some purposes and/or as used in conjunction with certain application paradigms. In many instances, however, such approaches can be partially or wholly unsatisfactory in practice. For example, in many cases, the learning management system and the service provider will be remote from one another. At the same time, at least one of these entities (such as the learning management system) will be operably disposed within a protective network firewall. Such a firewall can make at least some of the desired information exchanges difficult to effect. For example, pushing the course material and/or corresponding metrics to the learning management system via an intermediary network entity may be utterly prohibited by such a firewall.

Such concerns can be addressed by, for example, providing a prearranged relationship between such network entities. Unfortunately, while often effective, such a technique often imposes considerable network management overhead (to establish and manage such authorized exchanges). This, in turn, can delay the desired exchange and/or increase (sometimes significantly) the overhead resources that are required to effect such control.

Various known attempts to address this quandary are therefore seen to typically require undue cost, personnel, and/or time resources.

### BRIEF DESCRIPTION OF THE DRAWINGS

The above needs are at least partially met through provision of the hub-based communications method and apparatus described in the following detailed description, particularly when studied in conjunction with the drawings, wherein:

FIG. 1 comprises a block diagram as configured in accordance with various embodiments of the invention;

FIG. 2 comprises a block diagram as configured in accordance with various embodiments of the invention;

FIG. 3 comprises a block diagram as configured in accordance with various embodiments of the invention;

FIG. 4 comprises a block diagram as configured in accordance with various embodiments of the invention;

FIG. 5 comprises a block diagram as configured in accordance with various embodiments of the invention;

FIG. 6 comprises a block diagram as configured in accordance with various embodiments of the invention;

FIG. 7 comprises a flow diagram as configured in accordance with various embodiments of the invention;

FIG. 8 comprises a block diagram of a hub as configured in accordance with various embodiments of the invention;

FIG. 9 comprises a signal flow diagram as configured in accordance with various embodiments of the invention; and

FIG. 10 comprises a signal flow diagram as configured in accordance with various embodiments of the invention.

Skilled artisans will appreciate that elements in the figures are illustrated for simplicity and clarity and have not necessarily been drawn to scale. Also, common but well-understood elements that are useful or necessary in a commercially feasible embodiment are sometimes not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a process manager platform can facilitate its access to a given service provider via a data network by identifying a corresponding communication target (such as, for example, the service provider itself and/or a product that corresponds to that given service provider). The process manager platform can then automatically use a data translation and manipulation process to access a hub via the data network. Upon receiving a particular response from that hub, the process manager platform can then automatically use that response to facilitate establishment of communications with the desired service provider via the data network.

Depending upon the embodiment, the data translation and manipulation process can be partially or wholly facilitated by a corresponding data translation and manipulation unit. The latter can serve as a communications intermediary (such as a protocol intermediary) to facilitate compatible communications between the process manager platform and the hub that serves as an intermediary between the process manager platform and the service provider for at least some communications. Depending upon the embodiment, this data translation and manipulation unit may facilitate indirect communications with the service provider or more direct communications. In many embodiments it will also be desirable to provide a corresponding data translation and manipulation unit for the service provider as well.

Such embodiments can be successfully deployed and utilized without requiring undue administrator or administrative resources to ensure, for example, firewall compatibility. In particular, these embodiments are compatible with a wide variety of end user entities that themselves lack native compatibility with one another. So configured, a wide variety of service providers can compatibly and usefully provide a correspondingly wide variety of services and content to a large number of process management systems without any requirement that such entities be intrinsically compatible with one another and without requiring undue overhead attention to ensure compatible interoperability. These and other benefits will become more clear upon making a thorough review and study of the following detailed description.

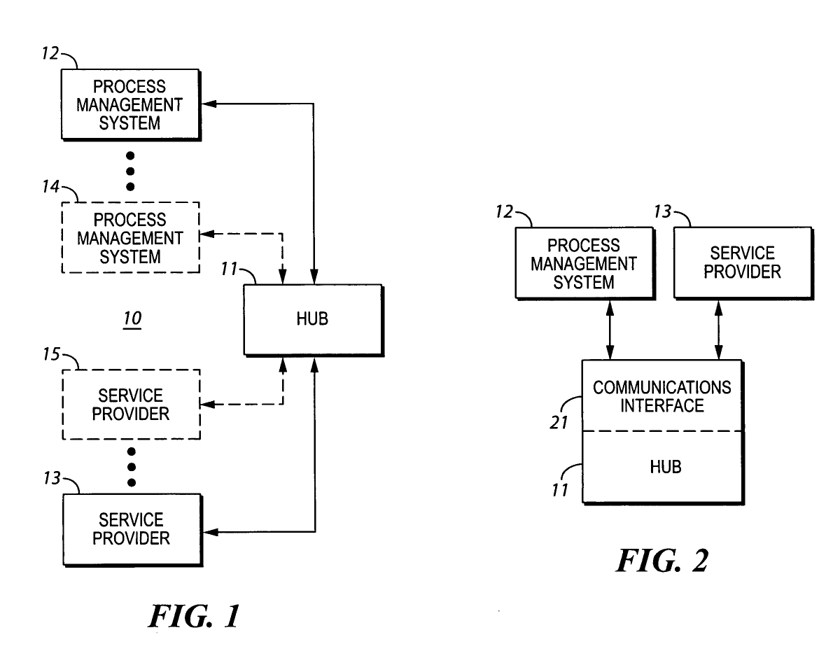

Referring now to FIG. 1, a preferred embodiment will typically comprise a system 10 having at least one hub 11 that operably communicates with at least one remotely located process management system 12 and at least one remotely located service provider 15. (“Remotely located” refers generally to something that is physically located in an area that is remote from another point of reference. For example, “remotely located” can refer to a juxtapositioning that includes being separated by continents, countries, states or territories, cities or other municipalities, campuses, enterprises, buildings, or one or more rooms, to name a few examples.) Such a hub 11 can further operably communicate with additional process management systems 14 and/or service providers 13 as appropriate or necessary to a given application. Depending upon the circumstances of a given deployment, such communications can be effected over an intranet or an extranet (such as, for example, the Internet). (The general configuration and operation of such networks are well known in the art and the specific details thereof are not particularly specific or relevant to an understanding of these embodiments. Therefore, for the most part additional details of such networks will not be provided here in order to enhance clarity and contribute to brevity.)

With reference now to FIG. 2, in a preferred embodiment the hub 11 can further comprise a communications interface 21 that effects this operable coupling to the process management system 12 and the service provider 13. If desired, this communications interface 21 can directly facilitate compatible communications with the process management system 12 and the service provider 13. More typically, however, this communications interface will not necessarily provide native compatibility with every process management system and/or service provider to which the hub operably couples. That is, the communication interface 21 may support compatible information exchange with the hub 11 itself but not direct inherently compatible information exchanges with other external platforms such as the process management system 12 and/or the service provider 13. It will also be understood that the communication interface 21 can comprise an integral platform that accommodates one or more differing interfaces (as suggested by the illustration) and/or can comprise a plurality of physically discrete interfaces that are selected and configured to operate compatibly with corresponding external platforms as other described above.

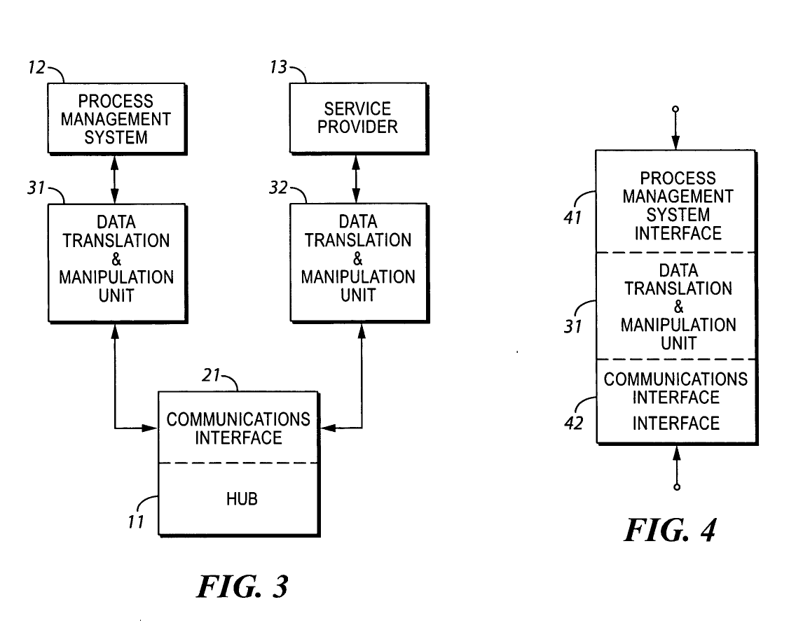

So configured, and referring now to FIG. 3, data translation and manipulation units 31 and 32 can be provided to effect compatible communications between the process management system 12 and the service provider 13, respectively, and the hub 11 via the communications interface 21. More specifically, and referring now to FIG. 4, a given data translation and manipulation unit such as the process management system data translation and manipulation unit 31 can comprise a communications interface interface 42 that interacts compatibly with the communications interface 21 of the hub 11 and can further comprise a process management system interface 41 that similarly effects compatible interaction with the process management system to which it couples.

So configured, the data translation and manipulation unit 31 can compatibly receive information from the process management system and translate and manipulate that information into a form that is compatible for provision to the communications interface of the hub. Similarly, the data translation and manipulation unit 31 can compatibly receive information from the communications interface of the hub and translate and manipulate that information into a form that is compatible for provision to the process management system. Those skilled in the art will be familiar with various data translation and/or manipulation techniques and platforms that can be suitably applied to realize such an embodiment. Therefore, additional details regarding such data translation and manipulation units will not be provided here expect where useful to the description of a particular embodiment.

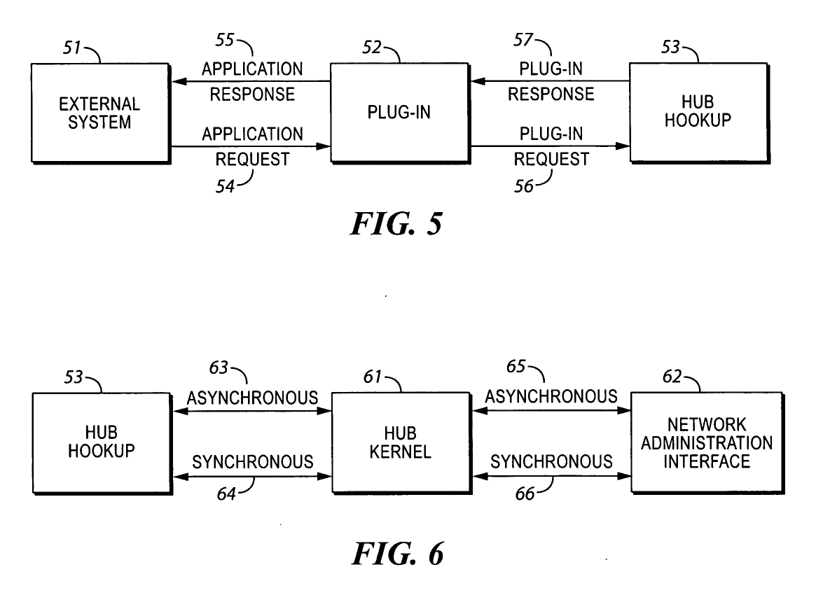

FIG. 5 provides a more detailed view of an example of how an external system 51 (such as a process management system or a service provider) can operably couple to the communications interface of a hub (represented here by a hub hookup 53). In this embodiment and illustrative example, the data translation and manipulation unit can be comprised of a plug-in 52 and more particularly can be viewed as comprising one or more device drivers and/or adapters as appropriate to facilitate the desired degree of compatibility.

A given external system 51 can deliver an application request 54 to seek to initiate a hub-related action (such as eliciting a specific information response from a hub). This application request 54 can comprise, for example, a network data request (such as but not limited to a uniform resource locator as is otherwise well understood in the art; for convenience, subsequent references to such a request will tend to refer to such locators but it shall be understood that such references are for convenience only and that such references will be understood to encompass the broader general concept of a request) that corresponds to the plug-in 52 along with information specific to the external system itself 51. Since the application request 54 has the form of a uniform resource locator, standard communication protocols can be employed that are typically firewall transparent. In general, and pursuant to a preferred approach, the uniform resource locator should identify the operation of the request and should provide a callback uniform resource locator that the plug-in 52 can use to communicate with the external system 51 when necessary (for example, to deliver requested results, to request additional information, and so forth).

Such an application request 54 can invoke either a synchronous or an asynchronous operation as desired or required with the nature of the operation likely depending upon the specific situation or platform (again in accordance with well understood prior art technique).

Depending upon the embodiment, upon receiving the application request 54, the plug-in 52 determines whether additional information is required. When true, the plug-in 54 requests such information and the external system 51 can respond by, for example, posting a relevant document to the plug-in 52. The latter can then parse such a document for the relevant information. Other approaches can also be taken, of course, to facilitate the request and/or provisioning of such supplemental information (for example, other network entities, such as servers that traffic in such information, can be contacted as necessary).

Upon determining that all necessary information is available, the plug-in 52 forms a plug-in request 56 and provides that request 56 to the hub hookup 53. In a preferred embodiment, this request 56 comprises a dynamically created object that forms a bridge from the plug-in 52 to the hub kernel itself. So configured, the hookup object can facilitate direct communications with the hub kernel.

The hub hookup 53 then offers a plug-in response 57 to the plug-in 52. In one embodiment, this response 57 can comprise a Java object (such as, but not limited to, a Java bean) that houses the data of interest and the operations the plug-in 52 needs in order to complete the application request 54. The plug-in 52 then uses the plug-in response 57 to take one or more appropriate actions. This can include, for example, launching another application or simply forming a corresponding application response 55 of some kind that the plug-in 52 delivers to the external system 51.

Depending upon the needs of an immediate and specific implementation, the plug-in 52 may communicate numerous times with the hub kernel (via the hub hookup 53) in order to service a single application request 54. As one specific illustration, when the external service 51 comprises a learning management system for a corresponding enterprise, and when that learning management system is seeking to launch a specific course as is offered by a specific corresponding service provider, the plug-in 52 may contact the hub kernel a first time to obtain a launch uniform resource locator as corresponds to the specific course then a second time to obtain the course results for delivery to the learning management system.

So configured, all (or substantially all) data moves from one component to another as elements of a network data request that pulls the data into the receiving component. This aids in ensuring that no element pushes data in a manner that can induce unwanted and unsatisfactory interaction with a firewall that otherwise serves to protect the enterprise that initially posits the application request 54. In substantial effect, these substantive communications occur substantially transparent to any such firewall.

A given deployment consistent with these teachings will likely include deployment within the Internet. Accordingly, one or more systems or elements can (and likely will) go offline or otherwise become temporarily unavailable for varying amounts of time on an unscheduled basis. Such service breaks can even occur in the middle of a given transaction. Accordingly, it may be desired to optionally configure a plug-in to maintain all transactions in a private queue and to hold them there pending receipt of an appropriate corresponding response. In the case of synchronous events, the plug-in can maintain the transaction in such a queue until the plug-in receives the appropriate response. In the case of asynchronous events, the plug-in can maintain the transaction in such a queue until a corresponding anticipated event (such as the hub kernel acknowledging its receipt).

Referring now to FIG. 6, components around the hub kernel and their interaction will be described in more detail. In general, it can be seen and appreciated that the hub kernel 61 (i.e., the hub processing core) typically only responds to external events; in general, the hub kernel will not, for example, “push” data to a process management system in the absence of a request for such information or an instruction from another external entity to provide such information. Consequently, and in accord with a preferred approach, the hub will typically have only a single network interface application (such as, for example, a single web application) that serves as a network administration interface 62. Such an administration interface 62 can provide system administration personnel a means for manipulating the hub kernel 61 itself (i.e., its programming, functionality, and behaviors). The kinds of operations that are made available to the administration interface 62 can be as many and as varied as may be needed to suit the needs of a given application and can include, but are not limited to, the installation of customer access licenses, registration of new plug-ins, deactivation of certain customers, maintenance of one or more data repositories, and so forth.

FIG. 6 depicts a single hub hookup 53 for purposes of simplicity and clarity. In general, however, there will be numerous hub hookups. In a preferred embodiment, in fact, there will be one such hub hookup for each supported plug-in. To illustrate, when a given hub supports two learning management systems, 15 courseware modules, a human resources management system, a skills management system, and a compliance module (with all of these illustrative external systems being known and recognized in the art), the hub kernel 61 would preferably itself then operably couple to 20 corresponding hub hookups.

It should also be noted that any given hub hookup can have a variable useful lifetime. A given hub hookup may exist only to process a single request while another may have a considerably longer anticipated life span and can serve to process several transactions. In a preferred approach, the number of plug-ins will determine the number of active hookups.

As noted earlier, the hub kernel 61 may be interacting with synchronous and/or asynchronous communications. (A synchronous communication is typified by an initiator that blocks after transmitting a request pending receipt of a response.) Regardless of whether the hub hook-up 53 or the network administration interface 62 provides a synchronous (64 or 66, respectively) or an asynchronous (63 or 65, respectively) communication, the hub kernel 61 will preferably not itself engage in blocking. Instead, the hub kernel 61 will preferably pass a request on to the relevant component for corresponding processing and will then maintain the communication channel(s) to permit routing of the provided response to the initiating external system.

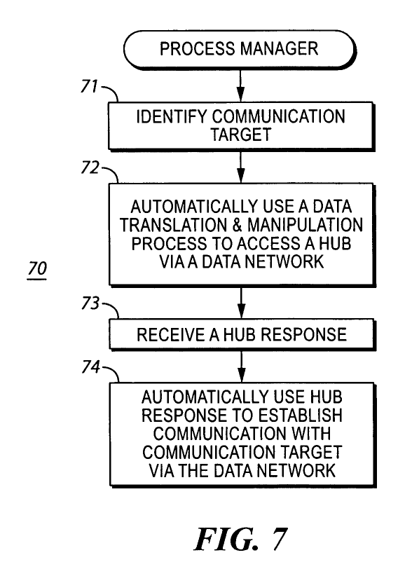

So configured, and referring now to FIG. 7, a given process manager (such as a process management system) can identify 71 a given communication target of interest and then automatically use 72 a hub-hookup compatible data translation and manipulation process to access the corresponding hub via the data network. It will be understood that identification of a given target can comprise identifying at least one of a given service provider and a product that corresponds to the given service provider (such as, for example, the data translation and manipulation unit that corresponds to the given service provider). Upon receiving 73 a response from the hub, the processor manager can then automatically use 74 that response to facilitate establishment of communications via the same data network with the given service provider. As will be shown below, this process 70 can further comprise receipt of a message from the data translation and manipulation process to provide additional information (as may be useful or necessary to permit processing of the original request, for example) and the automatic provision of such additional information to the data translation and manipulation process.

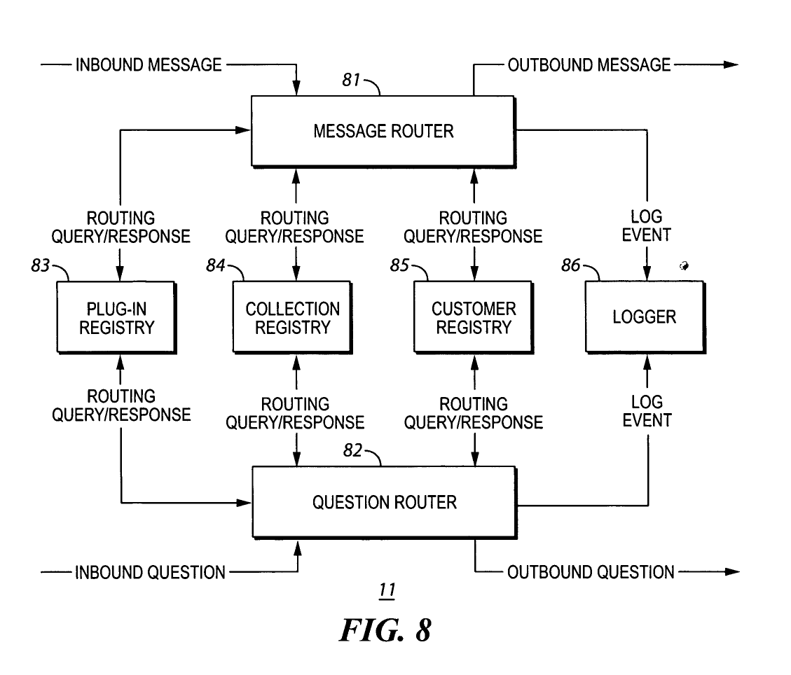

Referring now to FIG. 8, a more detailed description of an exemplary preferred embodiment of a hub 11 will now be presented. In this embodiment, a message router 81 (essentially to handle inbound and outbound messages comprising asynchronous communications) and a question router 82 (essentially to handle inbound and outbound questions comprising synchronous communications) each optionally operably couples to each of a plug-in registry 83, a collection registry 84, a customer registry 85, and a logger 86. Other registries or collections may also be provided, of course, as appropriate to suit the needs of a given application.

The message router 81 serves in a preferred embodiment to determine when an initiating external system comprises a valid, active customer who has the requisite authority to access, for example, a particular service provider. The message router 81 can also serve to confirm that the intended service provider's plug-in is, in fact, known to the hub 11. Note that since the message router 81 services asynchronous processes, a response to an earlier asynchronous request is treated as a new asynchronous message that has no external connection to the original request.

The question router 82 serves in a preferred embodiment to determine when an initiating external system comprises a valid, active customer who has the requisite authority to access, for example, a particular service provider. The question router 82 can also serve to confirm that the intended service provider's plug-in is, in fact, known to the hub 11. The question router 82 can also preferably serve to route responses as received from the service provider back to the corresponding initiating external system.

Generally speaking, the plug-in registry 83 comprises a registry of information that identifies at least some of the data translation and manipulation units to which the hub has access via its communications interface(s). The plug-in registry 83 comprises, in this embodiment, a catalog of plug-ins that are attached to or otherwise are available to the hub 11. When a request arrives (either in message or question format), the hub utilizes this registry 83 to determine if a plug-in exists that can service the request. (Depending upon the embodiment, this determination can include determining whether a suitable plug-in is locally available and/or whether a remotely available suitable plug-in can be accessed.) This registry 83 can also be used to gather specific plug-in information as may be usefully retained in this registry (such as, but not limited to, location information, information regarding which customers are licensed to use which plug-ins, and so forth). To facilitate such utility, of course, this plug-in registry 83 will preferably be updated with the appropriate information as it becomes available to the hub 11.

The collection registry 84 generally comprises a content registry that identifies at least some discrete content as offered by at least one service provider. The collection registry 84 comprises, in this embodiment, a collection of course catalogs as are known to the hub 11. Such a collection registry 84 will support a service model wherein individual customers of the hub are licensed to access all or some catalogs of courses by providing this resource. So configured, the hub can access the collection registry 84 to determine if a particular customer has predetermined authorization to access a given collection.

The customer registry 85 comprises, in this embodiment, a catalog of customers that are licensed to utilize the services of the hub (as distinct from more particular or content-specific licensing as can be reflected and tracked by the collection registry 84). In a preferred embodiment customer license keys are installed in the customer registry 85 (such license keys can indicate which plug-ins a given customer has authorization to access). This registry can be used, for example, to aid in controlling the access that customers have with respect to particular modules as may be provided by certain service providers. Of course, this customer registry 85 can also serve as a point of primary authorization to aid in determining whether a given inquiring party has pre-established authority to access the hub (or any of the service providers) at all.

The logger 86 comprises, in this embodiment, a component that records an audit trail and troubleshooting information regarding the actions and activities of the hub 11. More particularly, the logger 86 contains information comprising an audit trail that reflects at least some instances of when and/or how various process management systems access the hub 11. Such information, when later retrieved, can inform subsequent diagnostic activities and the like. Event logging comprises a relatively well understood concept and practice in the art and further description here will therefore not be provided.

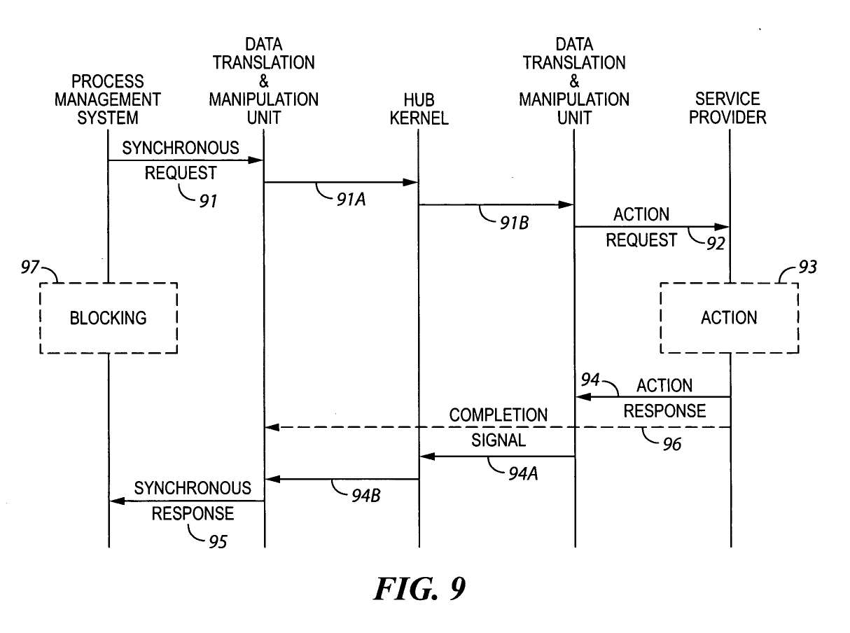

As noted above, the hub 11 can preferably attend to both synchronous and asynchronous communications. An illustrative synchronous communication will now be described with reference to FIG. 9. A particular process management system unilaterally creates a synchronous request 91 and transmits this request to its corresponding data translation and manipulation unit. This request can include various items of information including an identification of the sourcing process management system and, for example, an identification of a desired target service provider. Since this comprises a synchronous communication, the initiating process management system will then typically block 97 pending a response to this request. The data translation and manipulation unit passes this communication 91A to the hub kernel and on 91B to the data translation and manipulation unit as corresponds to the indicated service provider.

The latter then issues an action request 92 to the service provider. When the service provider completes the corresponding action 93, the service provider sources an action response 94, 94A, and 94B via its data translation and manipulation unit, the hub kernel, and the data translation and manipulation unit for the initiating process management system. The latter then forms and transmits a synchronous response 95 to the process management system (the latter then unblocking, waking up, and reacting in an appropriate manner to the response). (If desired, the service provider can also transmit an optional completion signal 96 directly to the data translation and manipulation unit for the process management system.)

So configured, the hub kernel serves, at least in part, to locate the proper destination for these requests and responses. In the forward direction, the hub kernel locates the data translation and manipulation unit for the service provider and forwards the request. In the reverse direction the hub kernel locates the original initiator and forwards the response to the initiator's data translation and manipulation unit.

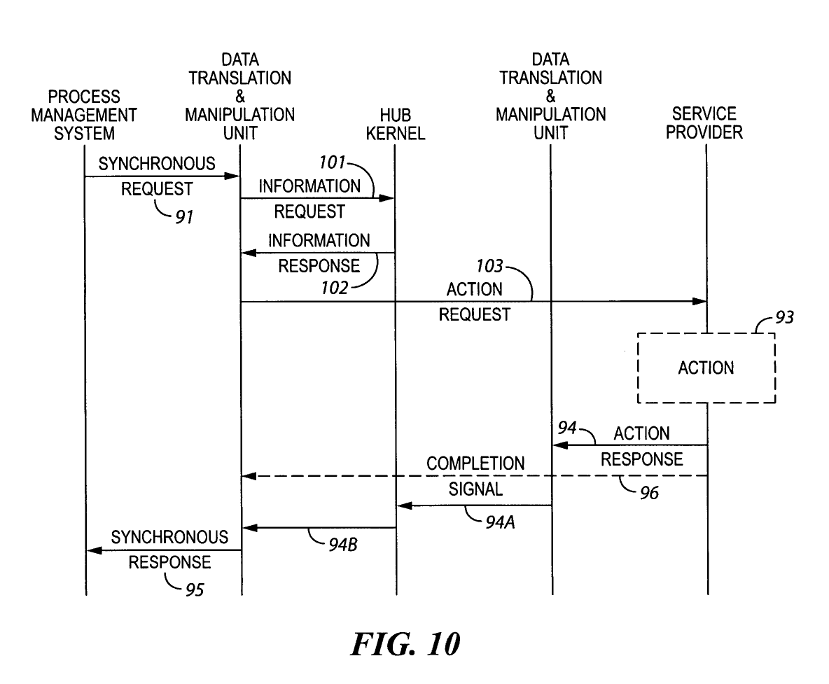

The above-described scenario is intended to be illustrative and not exhaustive. There are other ways in which these components can interact to effect similar results. For example, and referring now to FIG. 10, the data translation and manipulation unit for the process management system can query the hub kernel with an information request 101 as an initial reaction to receipt of the synchronous request 91 from the process management system. This approach can be used to permit the data translation and manipulation unit to obtain information in an information response 102 regarding the authorization of the process management system, the target service provider, the data translation and manipulation unit as is used by the service provider, and so forth. When, for example, the requested information serves to directly identify an address (such as a uniform resource locator address) for the data translation and manipulation unit for the service provider, the data translation and manipulation unit can then directly transmit its action request 103 thereto. The process can then proceed in a fashion as was previously described above.

Asynchronous communications between external systems and the hub 11 can be accommodated in a relatively similar manner. A primary difference is that none of the systems are likely to use blocking while waiting for a response during asynchronous exchanges. Once receipt of a message is acknowledged (in systems where such receipts are provided), the initiator will typically move on to other operations. Because asynchronous responses appear as a new incoming message to a process management system, it may be important to ensure that a firewall associated with such a process management system is configured to not bar such an asynchronous response.

A wide variety of services and needs can be readily accommodated by such platforms and methodologies. To illustrate, consider a user who seeks to launch a particular training course from their learning management system. To launch the course, the hub kernel will deliver a uniform resource locator that corresponds to the course to the initiator's plug-in so that the user's browser can be forwarded to the course.

In a synchronous example, the user launches an inbound question that identifies the customer and the collection that contains the desired course (the latter information may be known a priori to the user or may be determined in some other way as appropriate to the dictates or needs of a given configuration). The question router in the hub uses the customer registry to determine whether the identified customer is allowed to access the hub. Upon determining this, the question router then accesses the collection registry to verify that the customer is licensed to access the collection that contains the course. When true, the question router can then retrieve a list of all plug-ins for which the customer has authorization from the plug-in registry. Pursuant to one embodiment, the question router then polls each plug-in in this list to identify one or more plug-ins that can facilitate the inbound question. Upon locating such a plug-in, the question router then requests a course launch address from the plug-in and packages the corresponding information in a response that is delivered back to the initiator's plug-in. In a preferred embodiment the question router than sends event notifications to the logger to facilitate their recordation in a log or audit file.

Such embodiments have particular benefit when used to facilitate learning systems. For example, these embodiments are suitable to permit remote course launching (and particularly the launching of courseware located in various places on a network and essentially regardless of firewall placement). These embodiments also readily support the tracking of student progress and the recordation of course results even when, again, components are highly distributed. In general, a given customer should only need to install an appropriate hub-compatible plug-in and one or more relevant license keys. The system will then readily facilitate automatically tracking of the plug-ins and the customers that are associated therewith. These embodiments will also readily support the queuing of transactions. Such queuing will permit a given transaction to run to completion even when one or more components goes down in a temporary manner. In general, third party components only need to initially interact with the hub itself and do not require intimate knowledge of other third party components in order to successfully establish interaction with one another. In general, also, these embodiments permit and facilitate such interaction without necessarily requiring a firewall to open undesired holes in their protection.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A system comprising:
a hub;
at least one process management system that is located remotely with respect to the hub and that operably communicates with the hub;
at least one service provider that is located remotely with respect to both the hub and the at least one process management system and that operably communicates with the hub.

2. The system of claim 1 wherein the hub further comprises a communications interface that operably couples to the at least one process management system and the at least one service provider.

3. The system of claim 2 wherein the communications interface has no native compatibility with either of the at least one process management system and the at least one service provider.

4. The system of claim 3 wherein:
the at least one process management system operably couples to the communications interface via a first data translation and manipulation unit; and
the at least one service provider operably couples to the communications interface via a second data translation and manipulation unit.

5. The system of claim 4 wherein:
the first data translation and manipulation unit has a process management system interface that is compatible with the process management system and a communications interface interface that is compatible with the communications interface; and
the second data translation and manipulation unit has a service provider interface that is compatible with the service provider and a communications interface interface that is compatible with the communications interface.

6. The system of claim 1 wherein the hub further comprises a data translation and manipulation unit registry that identifies at least some of the data translation and manipulation units to which the hub has access via a communications interface.

7. The system of claim 1 wherein the hub further comprises a content registry that identifies at least some discrete content as offered by at least one service provider.

8. The system of claim 7 wherein the content registry further identifies which process management systems are permitted access to which items of the discrete content.

9. The system of claim 7 wherein at least one item of the discrete content comprises a catalog.

10. The system of claim 1 wherein the hub further comprises a first registry that identifies at least one process management system that is authorized to access the hub.

11. The system of claim 10 wherein the hub further comprises a second registry that identifies at least some of the data translation and manipulation units to which the hub has access via a communications interface and wherein the first registry further identifies which of the data translation and manipulation units the at least one process management system is authorized to access.

12. The system of claim 11 wherein the first registry and the second registry are discrete from one another.

13. The system of claim 11 wherein the first registry comprises the second registry.

14. The system of claim 1 wherein the hub further comprises a logger that contains information comprising an audit trail that reflects at least some instances of the process management system accessing the hub.

15. The system of claim 1 wherein the hub further comprises at least one of a synchronous router and an asynchronous router.

16. The system of claim 15 wherein the hub comprises both a synchronous router and an asynchronous router.

17. An eLearning system comprising:
a hub;
at least one learning management system that is located remotely with respect to the hub and that operably communicates with the hub;
at least one human resources management system that is located remotely with respect to the hub and that operably communicates with the hub;
at least one courseware service provider that is located remotely with respect to the hub, the at least one learning management system, and the human resources management system and that operably communicates with the hub.

18. The eLearning system of claim 17 wherein the learning management system and the human resources management system initiate communications with one another via the hub.

19. A method to facilitate accessing a given service provider via a data network comprising:
at a process manager platform:
identifying at least one of the given service provider and a product that corresponds to the given service provider to provide a communication target;
automatically using a data translation and manipulation process to access a hub via the data network;
receiving a response from the hub;
automatically using the response to facilitate establishing communications via the data network with the given service provider.

20. The method of claim 19 wherein the process manager platform comprises a learning management system.

21. The method of claim 19 wherein using a data translation and manipulation process to access a hub via the data network further comprises:
receiving a message from the data translation and manipulation process to provide additional information;
automatically providing at least some of the additional information to the data translation and manipulation process.

22. The method of claim 19 wherein receiving a response from the hub further comprises receiving a Java object.
